(19) United States
(12) Patent Application Publication
(10) Pub. No.: US 2004/0051413 A1
(43) Pub. Date: Mar. 18, 2004

(54) Kinetic energy transmission by using an electromagnetic clutch

(76) Inventor: Abraham Liran, Tarzana, CA (US)

Correspondence Address: Abraham Liran, 4673 Ellenita Ave., Tarzana, CA, 91356, US

(21) Appl. No.: 10/243,896

(22) Filed: Sep. 16, 2002

(51) Int. Cl. H02P 15/00; H02K 49/00

(52) U.S. Cl. 310/103

(57) ABSTRACT

Using electromagnetic or magnetic fields to transfer magnetic force from one rotating machine to another and a method of providing a smooth transition of kinetic energy between two rotating machines or between a rotating machine and a linear rail using a brushless electromagnetic coupling, with the possibility to fully control the speed of the rotating or moving machine by sensing the actual speed and regulating the electrical power to the electromagnetic clutch.

### REFERENCE TO RELATED APPLICATION

The present application is related to two patents entitled “Power Supply for Providing Instantaneous Energy during Utility Outage” Dated: Feb. 1, 2000, U.S. Pat. No. 6,020.657 and Dated: Mar. 20, 2001, U.S. Pat. No.: 6,204,572, by the same inventor but with no assignee.

### FIELD OF INVENTION

This invention relates to rotating machines and more specifically to transfer kinetic energy from one rotating machine to another thru electromagnetic or magnetic fields. The invention relates also to rotating machines that need to increase or decrease rotational speed from one machine to another with the ability to control the output speed electromagnetically for providing accurate speed to sensitive machines such as generators.

### BACKGROUND OF THE INVENTION

The need to reduce or increase the speed from one rotating machine to another is desired in many machines. The conventional method to transfer rotational energy from one rotating machine to another is done by using gearboxes. The main problem with using a gearbox is its reliability because the matching gears are under constant mechanical friction, which creates heat and weariness. Gears are also noisy, require constant lubrication and have a limitation on the maximum gear ratio that can be achieved between two matching gears. Usually the limit is less than 10. Furthermore, using a gearbox gives a fixed speed ratio between the input speed to the output speed that depends on the pitch diameter ratio between the two matching gears and therefore once the speed ratio has been determined, it is impossible to change it. If the input speed fluctuates, the output speed fluctuates as well. Anther existing method to replace a gearbox is to use an eddy current clutch, but its major disadvantage is its low efficiency that creates a great amount of heat, and thus it usually operates for just a few seconds. Machines such as generators that are required to provide accurate and fixed power and frequency to sensitive equipment such as computers, data processing, communication and many other sensitive systems, need a very accurate rotational speed. If we will turn a generator by a gas or diesel engine thru a gearbox, it will be impossible to maintain a fixed rotational speed on the generator due to irregularities in fuel supply to the engine or due to load changes. However, if we will turn the engine at a higher speed than the generator and we will use an electromagnetic transmission to transfer the required kinetic energy from the engine to the generator, as described in this invention, it is possible to provide an accurate speed to the generator even if there are load changes or engine irregularities.

U.S. Pat. No. 6,020,657 discloses uninterrupted power supplies using an AC motor to turn the flywheel and at the instant of a power outage, the AC motor becomes an Electromagnetic Clutch. This kind of clutch is not efficient and requires too much power to produce the required torque. In addition, this kind of clutch requires an expensive Variable Frequency Drive to control the speed.

U.S. Pat. No. 6,204,572 is similar to the previous patent but instead of using the AC motor as a clutch between the flywheel and the synchronous machine, we are using a combination of induction coils and induction bars facing each other axially. This kind of clutch creates axial forces between the synchronous machine and the flywheel that requires big clearances between the two parts of the clutch, which means a less efficient clutch and requires special expensive bearings to carry the axial forces. In addition, the magnetic loop for the magnetic flux is long and not efficient.

There is a need for a reliable, simpler and more effective transmission system which can efficiently transfer rotational speed with no mechanical friction, noise or limit on the speed ratio with the possibility to control and regulate the output speed, and that will be smaller and lighter than a gearbox. The present invention is describing such a transmission.

### SUMMARY OF THE INVENTION

The objective of this invention is to provide a reliable and continuous speed transmission at any required speed ratio, with the capability to control and regulate the output rotating speed to sensitive or critical equipments. This invention can replace gear-box transmissions very effectively while simplifying the design, improving durability and maintaining an accurate output speed even while the input speed is fluctuating.

This invention utilizes three main components: 1. the high speed disc that is connected directly to the primary rotating machine which could be an electric motor, rotating shaft or any kind of engine. 2. The low speed disc that contains the electromagnetic coils and is connected directly to the machine that its speed we need to control. 3. The split core transformer that, thru electromagnetic induction coils, it is possible to transfer AC electrical power from a stationary primary transformer coil to a secondary rotating transformer coil.

The electromagnetic transmission or clutch that is presented in this patent is described in FIG. 1 to FIG. 8. In order to transfer rotational torque from the high speed disc to the low speed disc, we need to energize electrically the electromagnetic coil that is attached to the low speed disc or to use permanent magnets. When the electromagnetic coil is energized, it creates a magnetic flux. The magnetic flux closes its path thru two radial, small air gaps between the high speed disc and the low speed disc. The high speed disc can move inside a circular slot in the low speed disc and the magnetic flux created either by an electromagnetic coil or by a permanent magnet attached to the low speed disc closes the magnetic path thru the two air gaps and thru the section of the high speed disc that is located between the two air gaps. The outer diameter of the high speed disc, in the section which rotates between the two air gaps, is made of ferromagnetic material and has axial open windows all around. Inside the windows are embedded conductive materials such as aluminum or copper. When the high speed disc moves inside the electromagnetic field created by the coil inside the low speed disc, we get electrical current induced in the ferromagnetic bars between the windows due to the relative rotational speed between the two discs. The return path for the electric current will be thru the conductive material embedded inside the windows. Because of the electric current that passes in the ferromagnetic bars which are under magnetic flux, we get an electromagnetic force between the low speed disc and the bars. This force provides the electromagnetic kinetic energy transmission or clutch between the high speed disc and the low speed disc. It is possible to control the amount of kinetic energy that we would like to transfer from one disc to the other by controlling the electrical current to the electromagnetic coils.

The electrical power to the electromagnetic coil is transferred thru a split core transformer. The primary coil of the split core transformer is a stationary coil that is energized with AC power. The secondary coil is attached to the low speed disc and faces the primary coil thru a small air gap. Electrical power is induced from the primary coil to the secondary coil and the AC power induced in the secondary coil is rectified by two power blocks. Each power block contains two diodes and the total four diodes create a rectifying bridge. The rectified power from the power blocks energizes the electromagnetic coil which provides the required force and torque to transfer kinetic energy from the high speed disc to the low speed disc or from the high speed disc to a linear rail—in the case of a linear motor.

### BRIEF DESCRIPTION OF THE DRAWINGS

Following are different kinds of applications for using the electromagnetic transmission or clutch.

FIGS. 1 and 2 are drawings of the rotary electromagnetic transmission assembly, using electromagnetic coils to create the required magnetic coupling between the high speed disc and the low speed disc.

FIGS. 3 and 4 describe an option to provide high torque electromagnetic transmission from a rotating high speed disc to a linear rail. This kind of transmission is fit for applications such as electromagnetic trains and high energy launch systems.

FIGS. 5 and 7 show different methods to transfer rotational kinetic energy from a high speed disc to a low speed disc. These methods are efficient and effective for cases that require a high speed ratio between the input to the output. The pitch diameter between the two discs can be designed for an optimal speed ratio to achieve high efficiency performance for a given speed ratio. FIG. 6 is a side view of the high speed disc that is shown in FIGS. 5 and 7.

All of the above descriptions describe the use of the electromagnetic coils to create the magnetic fields required to transfer the kinetic energy. However, it is possible to replace the electromagnetic coils with permanent magnets and to achieve the same result, except the option to control the amount of kinetic energy to be transferred. An example of how this can be done is given in FIG. 8.

### DETAILED DESCRIPTION OF THE PREFERRED EMBODIMENT

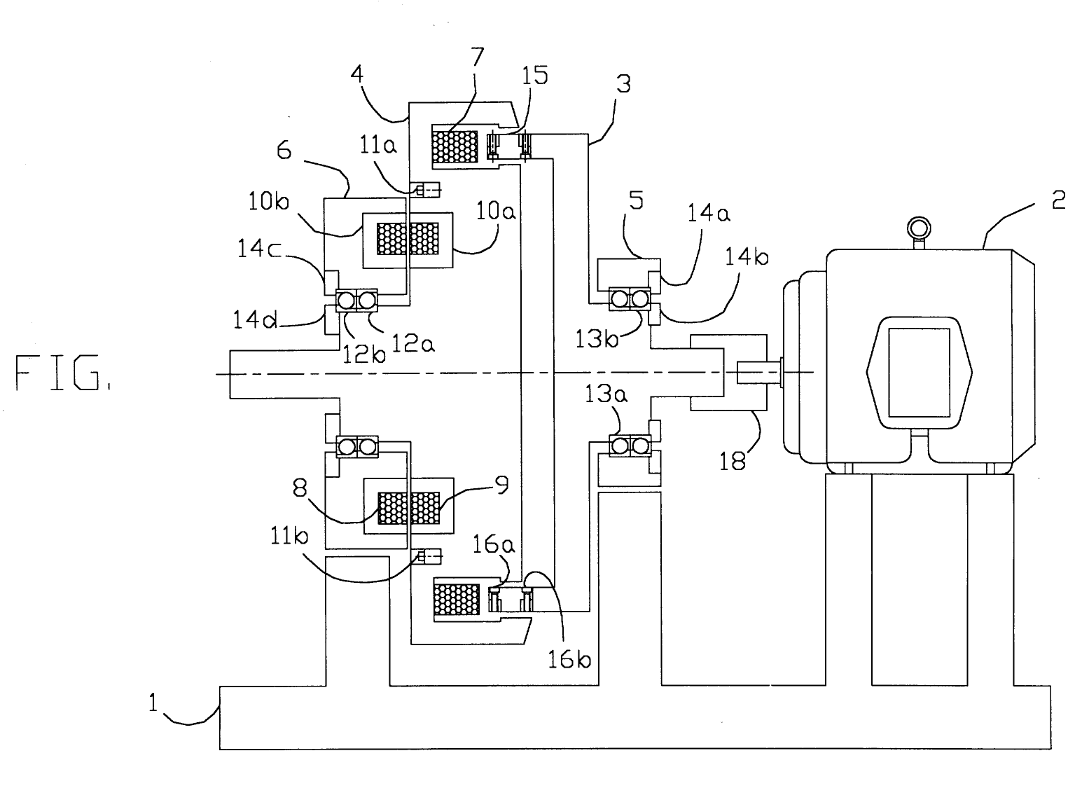

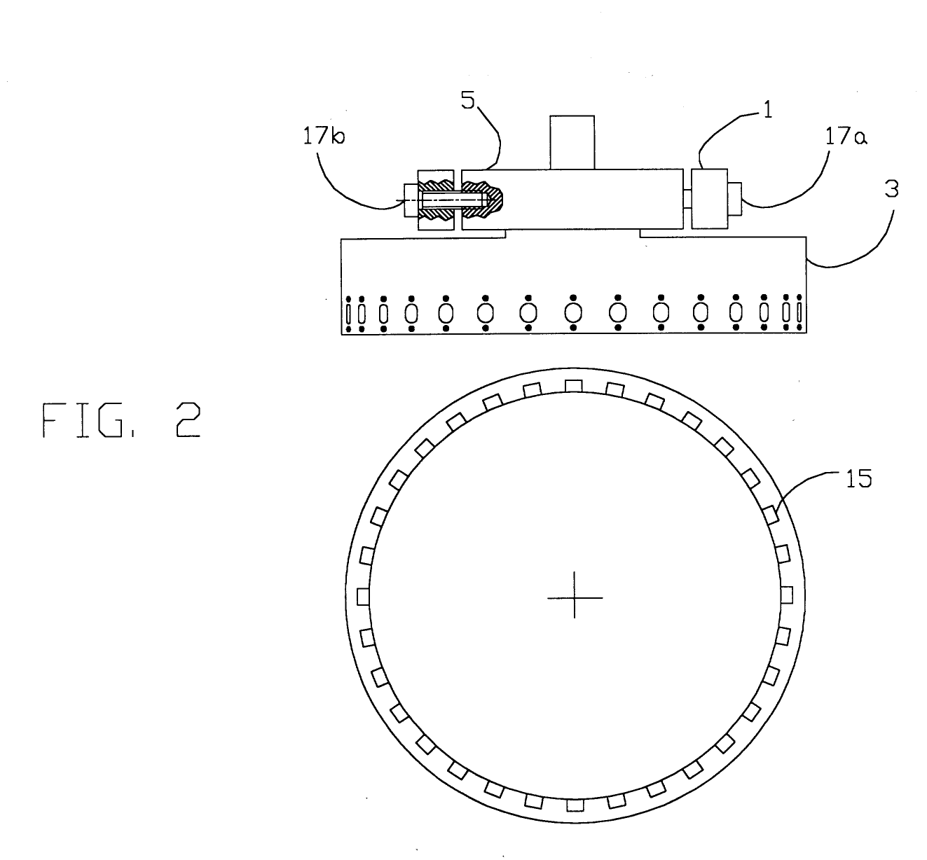

A description of the invention is provided with figures using reference designations. Referring to FIG. 1, the “electric motor”—2 turns the “high speed disc”—3 thru a “mechanical coupling”—18. If we will apply AC electrical power to the “primary coil”—8 which is part of the “split core transformer” the power will be induced to the “secondary coil”—9 of the split core transformer and faces the primary coil thru a small air gap. The “split core transformer” contains the following components: “laminations”—10a and 10b, embedded inside “bearing support”—6 and “low speed disc”—4, “primary coil”—8 embedded inside a radial groove in the “laminations”—10b and “secondary coil”—9 embedded inside a radial groove in “laminations”—10a. The AC power that is induced in the “secondary coil”—9 is rectified to a DC power by the “power blocks”—11a and 11b. The DC power from the “power block” energizes the “electromagnetic coil”—7, that provides the magnetic field to the electromagnetic coupling between the “high speed disc”—3 and the “low speed disc”—4. It is possible to control the speed of the “low speed disc” by sensing the output speed and regulating the current and voltage to the “primary coil”—8.

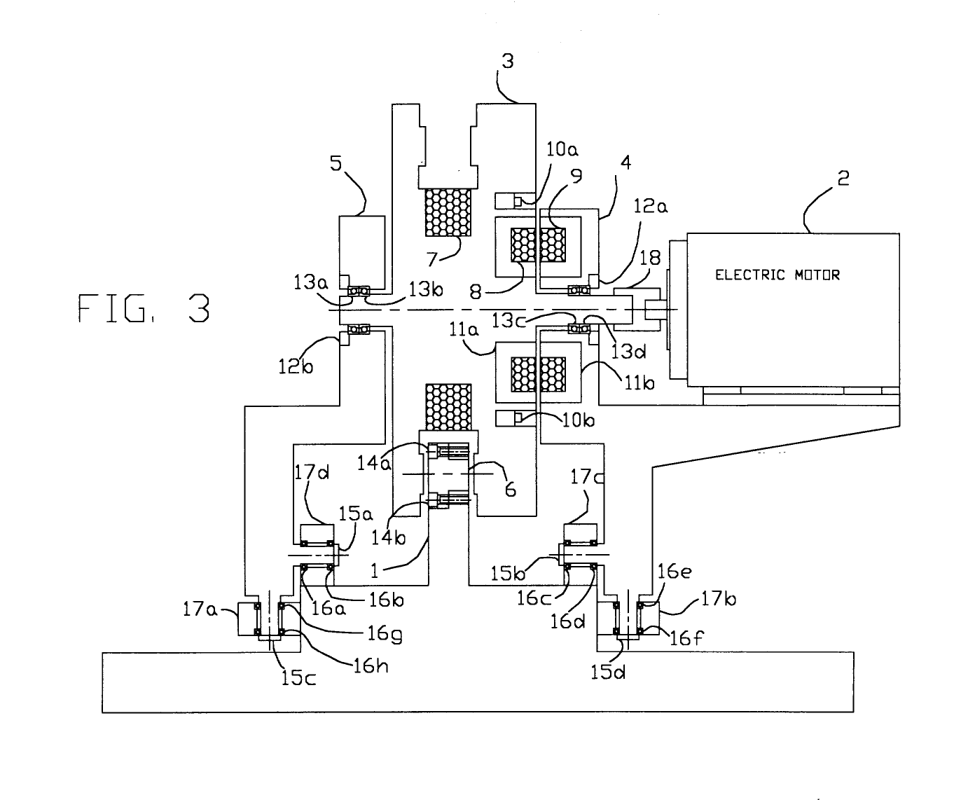

The bearings 13a and 13b support the “high speed disc”—3 and bearings 12a and 12b support the “low speed disc”—4. The bearings 13a and 13b are assembled inside a “bearing housing”—5 and the bearings 12a and 12b are assembled inside a “bearing housing”—6. “Bearing housings”—5 and 6 are attached to the “base”—1. It is possible to attach the “bearing housings”—5 and 6 to the base thru “hinges”—17a and 17b as shown in FIG. 2; this kind of “bearing housing” assembly eliminates any misalignment torque inside the bearings and prolongs the bearing's life.

FIG. 2 shows the windows on the ferromagnetic material of the “high speed disc”—3 in the area that rotates between the two air gaps inside the slot in the “low speed disc”—4. FIGS. 1 and 2 show the “electrical conductive material”—15 inserted inside the windows and bolted with screws 16a and 16b to the “high speed disc”—3.

Bearing 12a, 12b, 13a and 13b are preferably angular contact ball bearings such as SKF bearing 7036 to take radial loads as well as axial loads. Other kinds of bearings are also possible, including magnetic, electromagnetic, oil or air bearings.

The “power block”—11a and 11b such as EUPEC #DD171N14K contain two diodes in each block. The “low speed disc” is made out of a ferromagnetic material such as SAE1018. The “electromagnetic coil”—7 and the “primary” and “secondary” coils of the “split core transformer—8 and 9, is preferably made of copper wire with about 150 turns. However, the number of turns can change and it depends on the torque, the rotational speed that is required to transmit from high speed disc to low speed disc and the available input voltage to the electromagnetic coil.

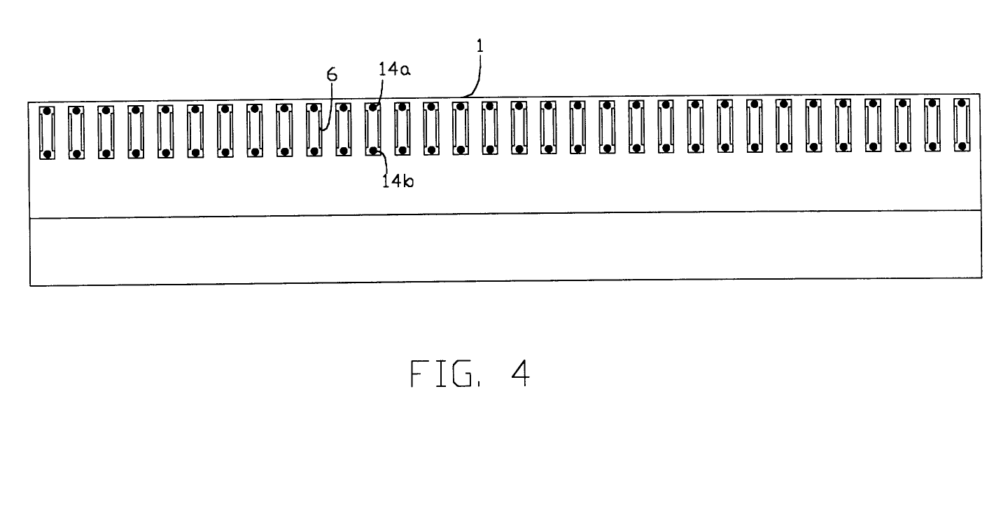

Referring to FIGS. 3 and 4: The “electric motor”—2 turns the “electromagnetic disc”—3 thru “mechanical coupling”—18. The “electromagnetic disc”—3 is mounted thru bearings 13a, 13b and is housed in “support”—5. Bearings 13c, 13d are housed in “support”—4. “Supports” 4 and 5 can move on top of “rail” 1 thru preferably sets of “wheels” 17a, 17b, 17c and 17d. The “wheels” have set of bearings: 16a, 16b, 16c, 16d, 16e, 16f and 16g. The set of bearings have locks for positioning: 15a, 15b, 15c and 15d. It is not a must to use the wheels and the ball bearings in order for the supports 4 and 5 to move on top of “rail”—1, among the other options are: air bearings and magnetic bearings. The side view of the “rail”—1 is shown in FIG. 4. The length of the rail is determined by the length travel required for a specific linear motor. The top section of the “rail”—1 is positioned between two narrow air gaps inside a slot in the “electromagnetic disc”—3. The top section of the “rail”—1 must be made of a ferromagnetic material and has array of opening windows. Inside the open windows are embedded “electrical conductive materials”—6, bolted to the “rail”—1 with screws 14a and 14b. This invention shows a method of using the “split core transformer” as described above to transfer electrical power without using brushes. The “electromagnetic disc”—3 has two sets of electrical coils, the “secondary coil”—8 of the split core transformer and the “electromagnetic coil”—6 that is embedded inside the radial slot in the “electromagnetic disc”—3 and when energized it produces electromagnetic flux. The electromagnetic flux closes its magnetic path thru the two air gaps and thru the upper part of the “rail”—1 which has the windows filled with the “electrical conductive material”—6. The “primary coil”—9 of the split core transformer is embedded in a radial groove inside laminations positioned axially in “support”—4 and the “secondary coil”—8 is embedded in a radial groove inside laminations positioned axially in the face of the “electromagnetic disc”—3. A narrow air gap exists between “support”—4 and the “electromagnetic disc”—3. The induced AC electric power in the “secondary coil”—8 is rectified by the two “power blocks”—10a and 10b. The rectified DC power from the “power blocks”—10a and 10b is connected to the “electromagnetic coil”—7.

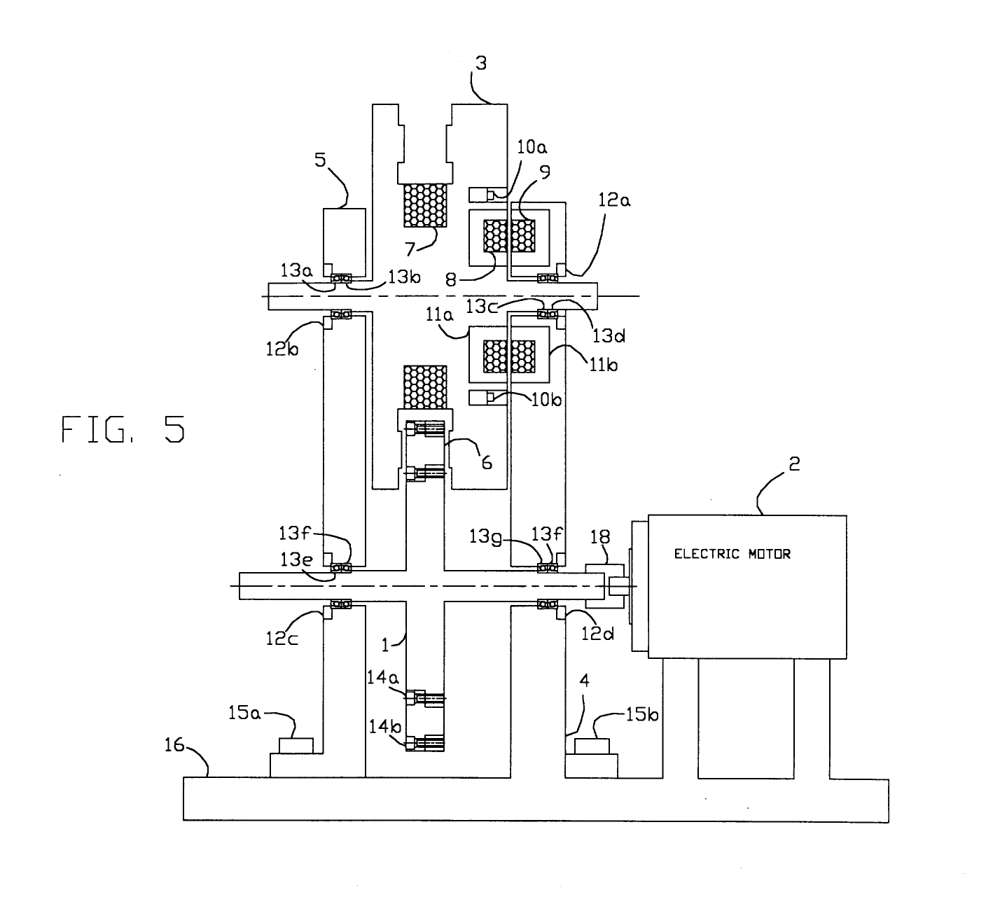

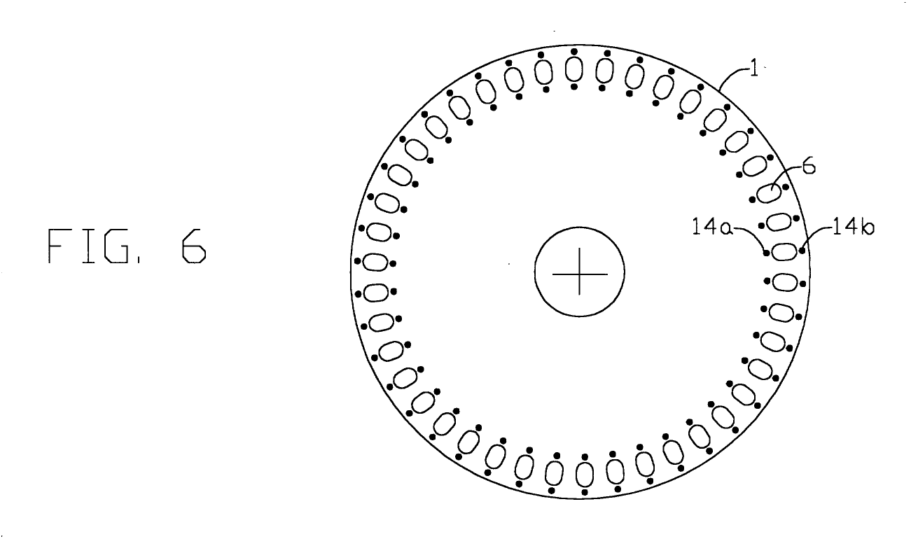

Referring to FIGS. 5 and 6: The “electric motor”—2 thru the “mechanical coupling”—18, turns the “high speed disc”—1 that is mounted thru bearings 13e and 13f that are housed in “support”—5 and bearings 13g and 13h that are housed in “support”—4. The set of bearings 13e and 13f are locked to the “support”—5 with “lock”—12c and the set of bearings 13g and 13h are locked to “support”—4 with “lock”—12d. “Supports” 4 and 5 are bolted to the “base”—16 thru “bolts”—15a and 15b. The outer diameter of the “high speed disc”—1 rotates inside a slot in the “low speed disc”—3 with small axial air gap between the two discs. In FIG. 5, the shown slot is in a radial direction; however, it can be directed in any angle. The outer diameter of the “high speed disc”—1 has windows shown in FIG. 6. The windows are field with an “electrical conductive material”—6 such as aluminum or copper bolted to the high speed disc with “screws”—17a and 17b. The material of the “high speed disc”—1, in the area where it is rotating inside the slot in “low speed disc”—3, must be made of a ferromagnetic material such as steel. The “low speed disc”—3 has two sets of electrical coils, the “secondary coil”—8 of the split core transformer and the “electromagnetic coil”—7 that is embedded inside the radial slot and when energized it produces electromagnetic flux. The electromagnetic flux closes its magnetic path thru the two air gaps and thru the outer diameter section of the “high speed disc”—1 which has the windows filled with the “electrical conductive material”—6. In order to transfer electrical power from a stationary coil to a rotary coil without using brushes, this invention shows a method of using the “split core transformer” as described above. The “primary coil”—9 of the split core transformer is embedded in a radial groove inside “laminations”—11b that are positioned axially in “support”—4 and the “secondary coil”—8 is embedded in a radial groove inside “laminations”—11a that are positioned axially in the face of the “low speed disc”—3. The face of the laminations that contain the primary coil—9 are opposite to the face of laminations that contain the secondary coil—8 and between the two discs we have a narrow air gap. If we will apply AC power to the primary coil—9, electrical AC power will be induced in the “secondary coil”—8. The AC power from the secondary coil will be rectified by the two “power blocks”—10a and 10b. The rectified DC power from the “power blocks”—10a and 10b will energize the “electromagnetic coil”—7 and magnetic flux will close the loop thru the two air gaps and thru the section of the “high speed disc” which is inside the slot. When the “electric motor” 2 or any other rotating shaft will turn the “high speed disc”—1 it will rotate freely as long we will not apply electrical power into the “primary coil”—9 and no magnetic flux exists. The moment we will have magnetic flux and the high speed disc will move inside it, the electromagnetic flux will create current inside the steel bars between the windows in the “high speed disc”—1 and the return path of the electrical current will be thru the “electrical conductive material”—6 inserted inside the windows. This current will interact with the magnetic flux and will create an electromagnetic force between the “high speed disc”—1 and the “low speed disc”—3. This force can transfer kinetic energy from the “high speed disc”—1 to the “low speed disc”—3 and the amount of force depends on the strength of the electromagnetic flux that will be created by the “electromagnetic coil”—7 and the relative speed between the “high speed disc”—1 and the “low speed disc”—3. It is possible to control the rotational speed of the “low speed disc”—3 by changing the current and voltage that we apply to the “primary coil”—9.

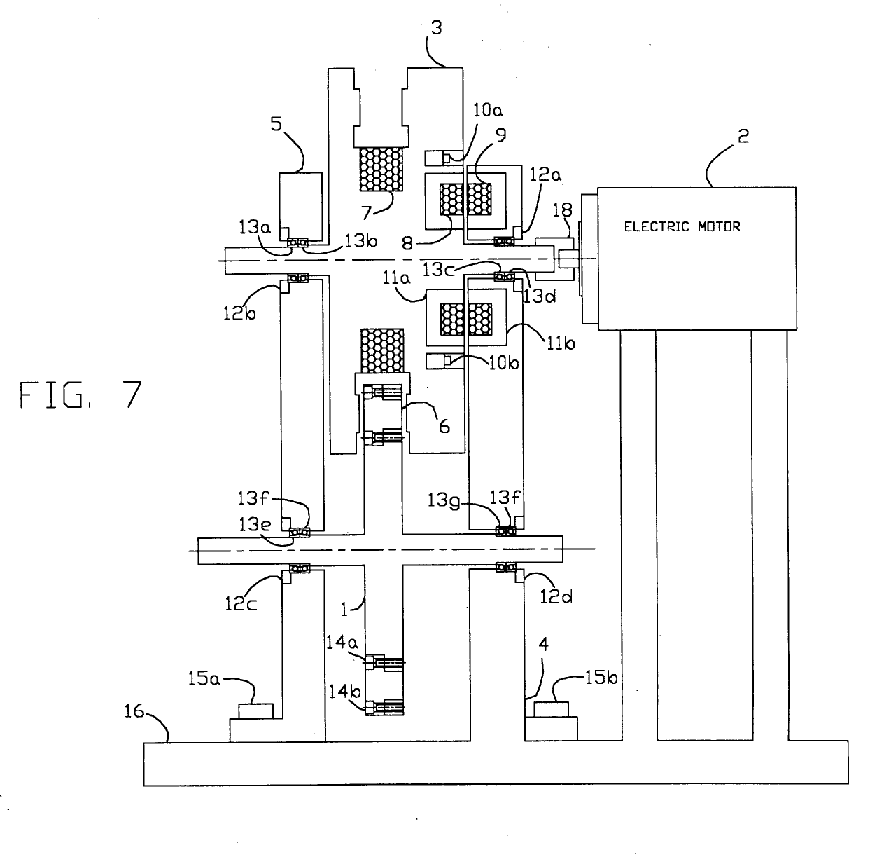

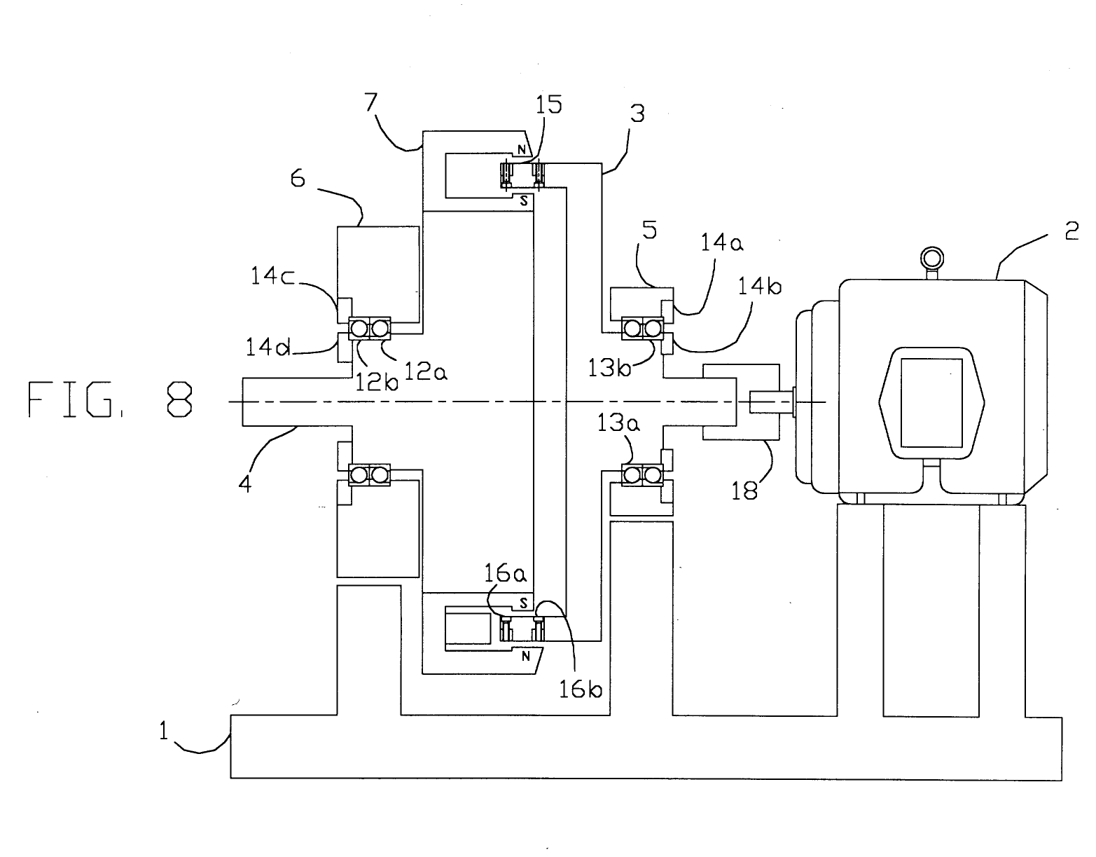

FIG. 7 is the same as FIG. 5 accept the “electric motor”—2 is coupled to the “low speed disc. This kind of arraignment also provides an option to increase the speed from the “low speed disc”—3 to the “high speed disc”—1.

Referring to drawing 8: FIG. 8 shows the same concept as FIG. 1, except that the “electromagnetic coil”—7 shown in FIG. 1 is replaced with a “permanent magnet”—7 and the split core transformer is not required. The “permanent magnets”—7 are made as a slotted ring. The slot creates a U section shape which is open in the axial direction, having one pole on the outer diameter and the opposite pole in the inside diameter of the slotted ring. It is possible to use other kind of permanent magnetic shapes to create the magnetic flux between the two rotating discs.

What is claimed is:

1. A method to transfer kinetic energy from one rotating machine to another machine thru electromagnetic or magnetic fields. The method comprises the steps of rotating a shaft at one rotational speed and using electromagnetic fields or using permanent magnets to create the magnetic field to transfer kinetic energy to a second shaft. If using electromagnetic coil or coils to create the magnetic fields, it is possible to control the amount of kinetic energy that the system will transfer. More specifically, the invention relates to rotating machines and linear moving machines that need to increase or decrease rotational or linear energy from one machine to another just thru electromagnetic or magnetic fields with the possibility to control the output speed for providing or continuously regulating the speed of the machines.

2. The method of claim 1 further comprises the step of using the “motor” to rotate the “electromagnetic disc” and to transfer the rotational speed to a linear motion by creating electromagnetic forces between the rotating “electromagnetic disc” and a linear “rail”.

3. The method of claim 1 further comprises the use of “hinges” to mount the bearing housings in order to minimize the mechanical torque on the bearings due to misalignment in the support of the bearings.

4. The method of claim 1 further comprises a way to transfer AC power from a stationary coil to a rotating coil using a split core transformer method. The split core transformer contains laminated ferromagnetic sheets inserted radially as two rings inside circular grooves. One laminated ring is inserted inside a groove in the stationary support and the other ring is inserted inside a groove in the rotating disc. A small air gap separates between the two laminated rings. An electromagnetic coil is embedded in each laminated ring in a circular groove. The coil that is embedded inside the groove in the lamination ring that is attached to the stationary support is the primary transformer coil, and the coil that is embedded inside the lamination ring attached to the rotating disc is the secondary transformer coil.

5. The method of claim 1 further comprises the use of electromagnetic coil or coils inserted inside a radial slot in a steel disc being rotated by a motor or any other rotating machine and another disc or rail moving inside the slot and having air gaps between the two parts. The disc or rail that is moving inside the slot made of steel or other ferromagnetic material has opening windows and the windows are filled with electric conductive material such as aluminum or copper.
